(19) United States
(12) Patent Application Publication
(10) Pub. No.: US 2014/0113759 A1
(43) Pub. Date: Apr. 24, 2014

(54) Drive Train Having a Hydrodynamic Retarder and Its Control Method

(71) Applicants: Achim Menne, Crailsheim (DE); Tilman Huth, Satteldorf (DE); Dieter Laukemann, Crailsheim (DE); Werner Koch, Deggingen (DE); Werner Klement, Heidenheim (DE); Martin Becke, Ulm (DE); Ravi Schade, Satteldorf (DE)

(72) Inventors: Achim Menne, Crailsheim (DE); Tilman Huth, Satteldorf (DE); Dieter Laukemann, Crailsheim (DE); Werner Koch, Deggingen (DE); Werner Klement, Heidenheim (DE); Martin Becke, Ulm (DE); Ravi Schade, Satteldorf (DE)

(73) Assignee: Voith Patent GmbH, Heidenheim (DE)

(21) Appl. No.: 13/883,981

(22) PCT Filed: Nov. 17, 2012
(86) PCT No.: PCT/EP2012/004788

§ 371 Date: Oct. 15, 2013

(30) Foreign Application Priority Data
Dec. 9, 2011 (DE) 102011120614.4

(51) Int. Cl. B60T 1/12

(52) U.S. Cl. CPC B60T 1/12
USPC 475/91

(57) ABSTRACT

The invention concerns a drive train
having a hydrodynamic retarder, by means of which the drive train can be braked hydrodynamically; wherein
the hydrodynamic retarder comprises a driven rotor and a stator or a driven rotor and a counter-rotor driven in reverse direction with respect to the rotor, which together form a working chamber which can be filled with working medium and which can be drained from said medium.

The invention is characterised in that
the hydrodynamic retarder is connected via a planetary gear to an element of the drive train guiding the drive power to the hydrodynamic retarder, and
the planetary gear has a hollow wheel drivingly connected to the element, at least one planetary gear rotatably carried by the planetary carrier and a sun wheel drivingly connected to the rotor of the hydrodynamic retarder, and
a brake is associated with the planetary carrier, by means of which the planetary carrier can be released in a first operating mode, in non-braking operation of the hydrodynamic retarder so that the planetary carrier can rotate over a planetary carrier axis, and can be braked and/or can be locked in a second operating mode, in braking operation of the hydrodynamic retarder.

The present invention concerns a drive train having a hydrodynamic retarder, in detail according to the preamble of claim 1, as well as a method for controlling the actuation of such a hydrodynamic retarder according to the preamble of claim 10.

Hydrodynamic retarders, which are used as wear-free continuous brakes for instance in motor vehicles on tracks as well as on the road, the latter in particular in lorries, exhibit no-load losses in non-braking operation, even if the working chamber, which is formed between the rotor and the stator or with counter-rotating retarders between the rotor and a counter-rotor driven in reverse direction, is emptied to a vast extent or until a predetermined residual amount of working medium. To eliminate the no-load losses completely, hydrodynamic retarders have been suggested which can be decoupled from the drive train by means of a separating clutch. We refer to the following documents by way of example:
EP 2 024 209 81
DE 199 27 397 A1
DE 10 2005 052 121 A1
DE 10 2009 001 146 A1,

Such a separating clutch is however prone to cause a damaging overload, for instance when it is closed by detrimental constraints or a malfunction, although the hydrodynamic retarder still generates a braking torque, and it causes disadvantageous integration efforts as well as additional maintenance requirements, when it is for instance incorporated into a motor vehicle transmission or is connected outside on said transmission.

The object of the present invention is to provide a drive train with a hydrodynamic retarder, whose no-load losses can be reduced via the emptying of working medium from the working chamber, without having to resort to the known friction clutches inflicted with shortcomings for switching on and off the hydrodynamic retarder.

The object of the invention is solved by a drive train exhibiting the features of claim 1 and a method exhibiting the features of claim 10. Advantageous and particularly appropriate embodiments of the invention are disclosed in the dependent claims.

The drive train according to the invention exhibits a hydrodynamic retarder, by means of which the drive train can be braked hydrodynamically. The drive train is for instance a motor vehicle drive train, in particular of a track vehicle or road vehicle, for instance a lorry. For that purpose, the drive train has then a drive motor, in particular an internal combustion engine, whose drive power is transmitted over a transmission, in particular a range change transmission to the drive wheels. The hydrodynamic retarder can be positioned on the primary side as well as on the secondary side of the transmission in the drive train. A particular arrangement can be found on a PTO (auxiliary power takeoff) of the internal combustion engine.

According to the invention, the hydrodynamic retarder has a driven rotor and a stator, which together form a working chamber which can be filled with a working medium and which can be drained from said medium. If a counter-rotating retarder shall be provided, a rotor driven in a first direction and a counter-rotor driven in the reversed direction can be provided which then together form the working chamber. Also multiflow retarders with a plurality of working chambers can be contemplated.

According to the invention, the hydrodynamic retarder is now connected via a planetary gear to an element of the drive train, guiding the drive power to the hydrodynamic retarder, which enables to disconnect or at least reduce the power flow to the hydrodynamic retarder, so that the rotor of the retarder is not driven any longer. The element guiding the drive power to the hydrodynamic retarder can be for instance a shaft in the or on the transmission or, as represented, the shaft of a power take-off of an internal combustion engine. Also another shaft, for instance in the direction of the drive power flow behind the transmission, for instance in or on the joint shaft, can be considered.

In addition to a shaft, other torque-transferring components can also be contemplated as an element transmitting the drive power to the hydrodynamic retarder.

The planetary gear comprises a sun wheel, a hollow wheel and at least one planetary gear carried on a planetary carrier. Several planetary gears carried on the planetary carrier can also be contemplated.

According to the invention, the hollow wheel is connected to the element guiding the drive power to the hydrodynamic retarder. By connection should be meant any suitable drive connection so that the hollow wheel is driven by the element guiding the drive power to the hydrodynamic retarder.

The sun wheel is connected to the rotor of the hydrodynamic retarder, whereas regards the connection, it is governed by the aforementioned. Any suitable drive connection, by means of which the sun wheel transmits the drive power or the torque to the rotor of the hydrodynamic retarder, can be considered. Consequently, the hollow wheel constitutes the input for the power transmission into the planetary gear and the sun wheel constitutes the output for the power transmission from the planetary gear as regards the power transmission of the drive power. Conversely, the breaking power to be more accurate the braking torque of the hydrodynamic retarder is transmitted backwards over the planetary gear, that is to say from the sun wheel via the at least one intermediate planetary gear to the hollow wheel and further to the element in the drive train, which connects the planetary gear to the drive train.

According to the invention, a brake is associated with the planetary carrier, by means of which the planetary carrier can be released in a first operating mode and can be braked and/or blocked against rotation in a second operating mode. The first operating mode corresponds to the non-braking operation of the hydrodynamic retarder. In such an operation, as far as no shifting clutch is provided, which is possible in an embodiment according to the invention, the hollow wheel of the planetary gear is driven further with the drive power of the drive train, which is fed for instance in coasting mode from the wheels of the vehicle into the drive train, however this enables only to drag along the planetary gear(s) without rotation or significant rotation of the sun wheel and hence of the rotor of the hydrodynamic retarder. Consequently, no-load losses generated in the retarder are extensively or completely avoided.

In the second operating mode, the brake mode of the hydrodynamic retarder, however, the planetary gear works as a mechanical power transmission, so that the whole or practically the whole drive power transmitted to the hollow wheel is transmitted via said at least one planetary gear to the sun wheel and hence to the rotor of the hydrodynamic retarder. In a particularly advantageous embodiment, a particularly large transmission ratio can be obtained between the hollow wheel and the sun wheel through the planetary gear so that the rotor of the hydrodynamic retarder can rotate significantly faster than the element guiding the drive power to the hydrodynamic retarder, for instance a main shaft in the vehicle transmission. In particular, a transmission ratio greater than 3 or 3.5 can be achieved.

Inasmuch as according to the invention a brake is used for interrupting or to a vast extent interrupting the power transmission to the rotor of the hydrodynamic retarder, a much higher “switching work” can be obtained compared with the use of a shifting clutch, without the threatening to overload the brake. Thus, it becomes possible to switch on the retarder also then into the power flow, when it is not completely emptied. Another advantage lies in that the structural design of the brake is substantially more favourable compared to a shifting clutch. For instance, we can use a brake of the type which is utilised with motor vehicle manual transmissions or cluster manual transmissions normally as a layshaft brake or such a multiple disk brake as it is applied to form the individual switching stages.

The brake is advantageously designed as a wet or dry running friction brake. For instance, a multiple disk brake, in particular comprising a large number of parallel lamellae respectively with one or several friction faces can be considered. Alternately, the brake can be designed as a synchronous element with friction cone. Also, a hydraulically or electromagnetically actuated brake can be considered, in particular one with self-reinforcement, which means that the actuating force introduced into the brake is amplified by the braking effect thereby generated.

To achieve a particularly high torque transmissibility when the brake is closed, i.e. when the brake is not slipping, the brake can be fitted with a mechanical lockup clutch by means of which the brake can be locked up in particular in a positively locking manner.

A common hydraulic or pneumatically control system can be associated to the brake and the hydrodynamic retarder, which generates a control pressure, by means of which the switching on and off of the hydrodynamic retarder is controlled by filling and emptying the working chamber and by means of which the opening and closing of the brake is controlled, in particular also the opening and closing of the lockup clutch of the brake.

It is advantageous that the brake has an actuator operated by the control pressure of the common control system for opening and closing the brake and the hydrodynamic retarder comprises a filling control device operated by the control pressure, whereas the actuator and/or the filling control device are such prestressed opposite to the control pressure or are temporarily separated from the control pressure by means of a valve unit in such a way that the actuator closes the brake at another control pressure, in particular a lower control pressure than the filling control device fills the working chamber of the hydrodynamic retarder with working medium. Consequently, the control pressure can exhibit a first control pressure range in which the brake is closed, and a second control pressure range, in which the working chamber of the hydrodynamic retarder is filled with working medium, whereas the brake remains closed. It is also possible to provide a third control pressure range, in particular between the first control pressure range and the second control pressure range, in which the closed brake is mechanically locked up by means of the lockup clutch whereas during subsequent or simultaneous filling of the working chamber of the retarder with working medium, the lockup clutch also remains closed.

The method according to the invention for controlling the actuation of a hydrodynamic retarder in a drive train, in particular motor vehicle drive train of the type represented, sets forth that in order to switch on the hydrodynamic retarder the planetary carrier is braked down by means of the brake and/or is locked mechanically to prevent any rotation and the working chamber of the hydrodynamic retarder is filled with working medium, and in order to switch off the hydrodynamic retarder the working chamber is emptied of the working medium and the brake is opened for releasing the rotation of the planetary carrier.

According to an embodiment, when switching on the hydrodynamic retarder, the planetary carrier first of all is braked down by means of the brake and/or is locked mechanically to prevent any rotation and subsequently the working chamber is filled with working medium. Alternately, the working chamber can exhibit a comparatively minimal partial filling level even in non-braking operation which is then increased only when the brake is closed completely or extensively. Due to the comparatively large braking capacity of a brake, an alternative form of embodiment however can also set forth that closing the brake, that is to say braking down the planetary carrier and filling the working chamber of the hydrodynamic retarder are performed simultaneously. It should only be guaranteed that no undesirable wear occurs in the brake nor that the maximum braking capacity is exceeded, and subsequently the maximum filling level, in particular the partial filling level of the working chamber are preset, which the brake can still sustain when slipping.

According to an embodiment, a filling level monitoring device is provided which detects the current filling level of the working medium in the working chamber. The detection can hence take place immediately in the working chamber or indirectly, outside said chamber. For instance, the filling level can be detected in an auxiliary chamber of the hydrodynamic retarder, which is more or less filled with working medium according to the filling level in the working chamber and which is designated in this instance as a communicating auxiliary chamber with reference to the principle of communicating vessels.

The filling level can be detected quantitatively or qualitatively. When the filling level is detected quantitatively, we only notice whether working medium is at all contained in the working chamber of the retarder or whether said chamber is emptied. When the filling level is detected qualitatively, the concrete filling level is detected continuously or in various stages. The detection can take place moreover permanently or at intervals.

A brake locking device can be provided, which is in communicating or mechanical operative connection and blocks any actuation of the brake according to the filling level detected. Such a brake locking device can be designed as a purely electronic control device which outputs a corresponding braking and/or locking signal for allowing a braking operation or for locking the braking operation by means of the brake. Alternately, the brake locking device can be designed as a physically or mechanically operating mechanism. Hybrid forms can also be envisioned.

According to an advantageous embodiment, the filling level monitoring device has a floater arranged in the working chamber of the retarder or a floater arranged in an auxiliary chamber communicating with the working chamber as regards the filling level of working medium.

Additionally or alternately, the filling level monitoring device can include an electric, optic or acoustic sensor and an associated interpreting unit, by means of which the filling level of the working chamber or another auxiliary chamber of the retarder communicating with working medium as regards the filling level is detected by an electric resistance measurement, an optic signal measurement or an acoustic signal measurement.

The control device can for instance calculate a limit rotation speed related to the filling level or resort to a filling level-related characteristic limit rotation speed line or characteristic limit rotation speed curve, which in particular is/are stored in the control device, whereas the control device blocks any actuation of the brake by means of the brake locking device in case of filling levels, when the corresponding current rotation speed lies above the corresponding limit rotation speed or characteristic limit rotation speed line. It can be explained as follows: Although an actuation of the brake when the working chamber of the retarder is filled, i.e. that said retarder generates a braking torque, can be seen substantially as detrimental as regards the durability/the wear of the brake, such an actuation can be admissible in the presence of comparatively small rotation speeds at the input of the planetary gear and/or of the planetary carrier, i.e. when accelerating the retarder to comparatively small rotation speeds by actuating the brake, since it should be noted that the braking torque generated by the retarder depends on the speed, relative to the revolution speed of the primary wheel of the retarder.

If the motor vehicle drive train is substantially designed in such a way that the retarder respectively its working chamber in deactivated condition, which means that when the retarder is not required to operate, should be emptied, the presence of working medium in the working chamber of the retarder in this state has an undesirable result. The consequence of this result can be that an actuation of the brake is prevented or locked during the following activation request due to advantageous measures taken, and hence the availability of the retarder is restricted. In order then to increase again the availability of the retarder in such an undesirable situation an embodiment according to the invention can provide that when locking the actuation of the brake measures are introduced which should induce an emptying of the working chamber in the next possible or favourable moment. We can then wait for instance once the actuation of the brake has been locked as afore mentioned, for the rotational speed at the input of the planetary gear and/or of the planetary carrier to fall down to a current value below the limit rotation speed or the characteristic limit rotation speed line and then the brake to be actuated also without any activation request or any activation signal for the retarder, so that the rotor of the same (at least the primary wheel) is brought into rotation and the working chamber is then pumped empty.

According to this embodiment according to the invention, the control device can exhibit a retarder activation signal input to which a signal is applied, which indicates an activation request for the retarder and the control device triggers the mentioned locking of the actuation of the brake in spite of the activation request, and after the locking, as soon as a current rotation speed lies below the limit rotation speed or the characteristic limit rotation speed line, independent of any further activation request or also then, in the absence of any activation request, control an actuation of the brake.

In an alternative embodiment of the invention, the emptying of the working chamber of the retarder, if the appropriate conditions for filling are not met and if the actuation of the brake has been blocked accordingly, can also take place by means of another unit, by way of example by driving the primary wheel and/or the secondary wheel of the hydrodynamic retarder, using an additional motor, in particular an electric motor or the working compartment can be pumped empty using a pump.

The invention will now be described by way of example using an embodiment.

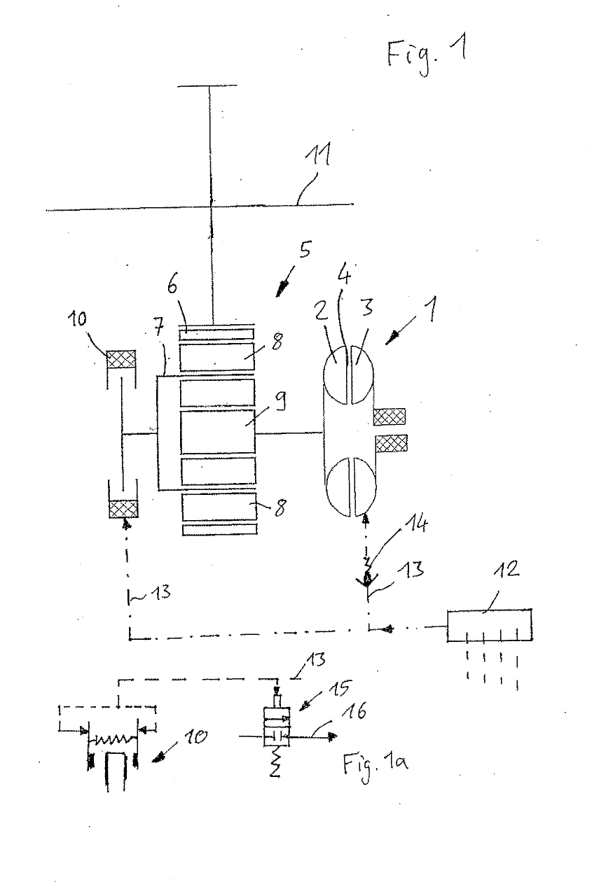

FIG. 1 represents a portion of a drive train with a hydrodynamic retarder 1 with the rotor 2, the stator 3 and the working chamber formed of the rotor 2 and stator 3. The rotor is driven via a planetary gear 5 by means of an element 11 guiding the drive power to the hydrodynamic retarder 1. The drive power flow takes place from the element 11 to the hollow wheel 6, via the planetary gears 8 carried on the planetary carrier 7, to the sun wheel 9 and further to the rotor 2.

According to the invention, a brake 10 is associated with the planetary carrier 7, by means of which the planetary carrier 7 can be braked completely, that is to say can be locked against any further rotation.

A common control system 12 is associated with the brake 10 and the hydrodynamic retarder 1, a system which generates a control pressure, which controls the filling of the working chamber 4 of the hydrodynamic retarder 1 as well as the braking down of the planetary carrier 7 by the brake 10. FIG. 1 represents by way of example a first possibility for generating different actuation pressure ranges of the control pressure and FIG. 1a shows a second possibility for that purpose. According to FIG. 1, the control pressure line 13 leading to a filling control device (not represented) of the hydrodynamic retarder 1 includes a return valve 14 which opens only above a predetermined pressure. The brake 10, however, is operated with control pressure also below said predetermined pressure via the control pressure line 13 and hence closed.

It goes without saying that a throttle or another appropriate element could be provided instead of the return valve 14, in particular a non-adjustable element, which generates a constant pressure drop or exhibits a constant cross-section, or an adjustable throttle element.

In the embodiment represented by way of example according to FIG. 1a, the control pressure in the control pressure line 13 works against different prestresses in the brake 10 and in the filling control device 15 of the hydrodynamic retarder, which is represented here by way of example as a directional valve, which opens and closes the inlet 16 for working medium to the working chamber of the retarder. The prestress is applied via appropriate elastic devices, whereas the latter is respectively represented as a spring.

It goes without saying that other measures can also be considered, to trigger the brake 10 and the filling of the hydrodynamic retarder 1 in the presence of different control pressures. Thus, the closing of the brake can trigger a mechanical or electromechanical or hydraulic/pneumatic actuation of a valve unit or of another appropriate element, which releases the filling of the working chamber 4 of the hydrodynamic retarder 1.

1-12. (canceled)

13. A drive train comprising:
a hydrodynamic retarder, by means of which the drive train can be braked hydrodynamically;
wherein the hydrodynamic retarder comprises a driven rotor and a stator or a driven rotor and a counter-rotor driven in reverse direction with respect to the rotor, which together form a working chamber which can be filled with working medium and which can be drained from said medium;
wherein the hydrodynamic retarder is connected via a planetary gear to an element of the drive train guiding the drive power to the hydrodynamic retarder;
wherein the planetary gear has a hollow wheel drivingly connected to the element, at least one planetary gear rotatably carried by a planetary carrier and a sun wheel drivingly connected to the rotor of the hydrodynamic retarder; and
wherein a brake is associated with the planetary carrier, by means of which the planetary carrier can be released in a first operating mode, in non-braking operation of the hydrodynamic retarder so that the planetary carrier can rotate over a planetary carrier axis, and can be braked and/or can be locked in a second operating mode, in braking operation of the hydrodynamic retarder.

14. The drive train according to claim 13, wherein the brake is designed as a wet or dry running friction brake.

15. The drive train according to claim 14, wherein the brake is designed as a multiple disk brake, in particular comprising a plurality of parallel lamellae with friction faces.

16. The drive train according to claim 14, wherein the brake is designed as a synchronous element with friction cone.

17. The drive train according to claim 13, wherein the brake is designed as a hydraulic or electromechanical brake.

18. The drive train according to claim 14, wherein the brake is designed as a hydraulic or electromechanical brake.

19. The drive train according to claim 15, wherein the brake is designed as a hydraulic or electromechanical brake.

20. The drive train according to claim 16, wherein the brake is designed as a hydraulic or electromechanical brake.

21. The drive train according to claim 17, wherein the brake is designed as a self-reinforcing hydraulic or electromechanical brake.

22. The drive train according to claim 13, wherein the brake has a lockup clutch, by means of which the brake can be locked up mechanically, in particular in a positively locking manner.

23. The drive train according to claim 14, wherein the brake has a lockup clutch, by means of which the brake can be locked up mechanically, in particular in a positively locking manner.

24. The drive train according to claim 15, wherein the brake has a lockup clutch, by means of which the brake can be locked up mechanically, in particular in a positively locking manner.

25. The drive train according to claim 16, wherein the brake has a lockup clutch, by means of which the brake can be locked up mechanically, in particular in a positively locking manner.

26. The drive train according to claim 17, wherein the brake has a lockup clutch, by means of which the brake can be locked up mechanically, in particular in a positively locking manner.

27. The drive train according to claim 18, wherein the brake has a lockup clutch, by means of which the brake can be locked up mechanically, in particular in a positively locking manner.

28. The drive train according to claim 13, wherein a common hydraulic or pneumatically control system is associated with the brake and the hydrodynamic retarder, which generates a control pressure, by means of which the switching on and off of the hydrodynamic retarder is controlled by filling and emptying the working chamber and by means of which the opening and closing of the brake is controlled.

29. The drive train according to claim 28, wherein the brake has an actuator operated by the control pressure of the common control system for opening and closing the brake and the hydrodynamic retarder has a filling control device operated by the control pressure, whereas the actuator and/or the filling control device are prestressed to oppose the control pressure and/or are separated from the control pressure by means of a valve unit in such a way that the actuator closes the brake at another control pressure, in particular a lower control pressure than the filling control device fills the working chamber of the hydrodynamic retarder with working medium.

30. A method for controlling the actuation of a hydrodynamic retarder in a drive train according to claim 13, wherein in order to switch on the hydrodynamic retarder the planetary carrier is braked down by means of the brake and/or is locked mechanically to prevent any rotation and the working chamber of the hydrodynamic retarder is filled with working medium, and in order to switch off the hydrodynamic retarder the working chamber is emptied of the working medium and the brake is opened for releasing the rotation of the planetary carrier.

31. The method according to claim 30, wherein in order to switch on the hydrodynamic retarder the planetary carrier is first of all braked down by means of the brake and/or is locked mechanically to prevent any rotation and subsequently the working chamber is filled with working medium or is filled above a preset maximum partial level.

32. The method according to claim 31, wherein the braking down of the planetary carrier and/or the mechanical locking of the planetary carrier as well as the filling of the working chamber with working medium is controlled by a common control pressure, whereas the braking down of the planetary carrier and/or the mechanical locking of the planetary carrier is performed at another control pressure, in particular a lower control pressure, than the filling of the working chamber.
